(19) United States
(12) Patent Application Publication
(10) Pub. No.: US 2024/0198640 A1
(43) Pub. Date: Jun. 20, 2024

(54) Multi-Layer Film With Heat Seal Properties

(71) Applicant: Celanese International Corporation, Irving, TX (US)

(72) Inventor: Jo Marshall, Derby (GB)

(21) Appl. No.: 18/545,088

(22) Filed: Dec. 19, 2023

Related U.S. Application Data
(60) Provisional application No. 63/433,801, filed on Dec. 20, 2022.

(51) Int. Cl. B32B 23/08; B32B 23/14; B32B 23/20

(52) U.S. Cl. CPC B32B 23/08; B32B 23/14; B32B 23/20; B32B 2250/02; B32B 2250/24; B32B 2307/31; B32B 2307/40; B32B 2307/54; B32B 2307/582; B32B 2307/7163; B32B 2307/7376; B32B 2553/00

(57) ABSTRACT

A multi-layer film is described and disclosed. The multi-layer film can be made from renewable resources. The multi-layer film can also be biodegradable and compostable. In one aspect, the film includes a cellulose ester polymer layer laminated to a bio-based polyester film layer. The bio-based polyester film layer provides heat seal properties, while the cellulose ester polymer layer provides tear resistance and better modulus properties.

### RELATED APPLICATIONS

The present application is based upon and claims priority to U.S. Provisional Application Ser. No. 63/433,801, having a filing date of Dec. 20, 2022, which is incorporated herein by reference.

### BACKGROUND

The majority of flexible packaging materials on the market for producing non-rigid packages are not sustainable or environmentally friendly. Instead, these materials are typically made from polymers derived from fossil-based resources. In fact, the production of these plastic materials continues to increase each year. After a package is opened, the packaging material is discarded and typically not recycled. Thus, the packaging material can end up in landfills where degradation rates are extremely slow.

For example, in the past, many flexible packaging materials have been made from multi-layer films containing polyethylene terephthalate polymers and/or polyethylene polymers. These polymers can provide excellent heat sealable properties but, again, are not sustainable.

In order to replace fossil-based polymers, in the past, those skilled in the art have suggested making packaging materials from a paper. Although paper is recyclable and compostable, paper does not have any heat seal properties. In addition, packages made from paper have little to no transparency properties. Thus, consumers cannot view the product contained within the packaging.

In view of the above, a need currently exists for a flexible packaging material that is compostable and/or sustainable. A need also exists for a flexible packaging material made from renewable resources that is heat sealable. A need also exists for a flexible packaging material made from sustainable resources that can be formulated to be transparent and has good tear resistant properties.

### SUMMARY

In general, the present disclosure is directed to a multi-layer film well suited for use as a packaging material that can be formulated to be sustainable and can be made exclusively from renewable resources. In one aspect, the flexible packaging material of the present disclosure can be constructed so as to be biodegradable and/or compostable. The multi-layer packaging film includes a bio-based polymer layer that also has excellent heat seal properties.

In one aspect, for instance, the present disclosure is directed to a multi-layer film comprising a first film layer bonded to a second film layer. The first film layer can comprise a cellulose ester polymer combined with a plasticizer. The cellulose ester polymer, for instance, can consist essentially of cellulose diacetate. Any suitable plasticizer can be combined with the cellulose ester polymer, such as triacetin, polyethylene glycol, or mixtures thereof. In one aspect, the first film layer contains a plasticizer in an amount from about 5% to about 45% by weight and the cellulose ester polymer in an amount from about 55% to about 95% by weight.

The second film layer is bonded to the first surface of the first film layer. The second film layer can comprise a heat sealable bio-based polyester polymer. For example, the bio-based polyester polymer can comprise a polybutylene succinate polymer. In one aspect, the second film layer can be directly bonded to the first surface of the first film layer without the use of an adhesive or an adhesive layer positioned between the first film layer and the second film layer.

Alternatively, the multi-layer film can further include a moisture and gas barrier layer positioned between the first film layer and the second film layer. The barrier layer can comprise, for instance, an aluminum oxide layer. The barrier layer may also comprise a cellulose-based layer, such as a layer made from cellulose particles or materials.

The multi-layer film can have any suitable thickness. For instance, the multi-layer can have a thickness of from about 10 microns to about 1,000 microns, such as from about 20 microns to about 500 microns. In one aspect, when used in thermoforming applications, the thickness of the multi-layer film can be from about 150 microns to about 400 microns. When forming flexible packaging, on the other hand, the multi-layer film can have a thickness of from about 20 microns to about 150 microns. The second film layer can have a thickness of generally greater than about 10 microns, such as greater than about 15 microns, and generally less than about 100 microns, such as less than about 50 microns, such as less than about 40 microns, such as less than about 30 microns. In one aspect, the first film layer can be thicker than the second film layer.

The multi-layer film of the present disclosure can have good transparency properties. For instance, the multi-layer film may display a haze when tested according to ASTM Test D1003 of less than about 20%, such as less than about 16%, such as less than about 14%, and generally greater than about 1%, such as greater than about 5%. The multi-layer film may display a tear propagation of greater than about 3 N, such as greater than about 3.5 N, and generally less than about 20 N. The multi-layer film may also display a Youngs Modulus of greater than about 700 N/m², such as greater than about 900 N/m², such as greater than about 1100 N/m², such as greater than about 1200 N/m², such as greater than about 1400 N/m², such as greater than about 1600 N/m², and generally less than about 3,000 N/m², such as less than about 2,500 N/m², such as less than about 2,000 N/m². Youngs Modulus can be tested according to ASTM D-882 (2018).

As described above, the multi-layer film can be formulated to be sustainable, biodegradable and/or compostable. For instance, a multi-layer film made according to the present disclosure having a thickness of 95 microns can pass the compostable test of EN 13432.

In one embodiment, the first film layer can comprise a cast film that is laminated to the second film layer. In laminating the two layers together, a polymer dissolving composition can be applied or sprayed in between the layers which causes the layers to bond together. For instance, the polymer dissolving composition can comprise acetone alone or in combination with a plasticizer. The second film layer can contain the polybutylene succinate polymer in an amount greater than about 70% by weight, such as in an amount greater than about 80% by weight, such as in an amount greater than about 90% by weight, such as in an amount greater than about 95% by weight.

All different types of articles and products can be made from the multi-layer film. In one embodiment, for instance, a package can be made from the film. The package can include flexible walls and can define an interior compartment defining an interior surface. The second film layer of the multi-layer film can form the interior surface.

In another aspect, the multi-layer film can be incorporated into a composite article. The composite article can include a fiber substrate comprising a network of biodegradable and/or paper recyclable fibers. The multi-layer film of the present disclosure can be laminated to the fiber substrate. The fiber substrate, for instance, can have a three-dimensional shape and the multi-layer film can be subjected to sufficient heat and pressure in order to assume the shape of the fiber substrate. The composite article, for instance, can comprise a tray or a container, such as a container for food items. For example, the fiber substrate can be in the shape of a container having an interior surface and an exterior surface. The multi-layer film can cover at least the interior surface of the composite article.

The fiber substrate, for instance, can be made from plant fibers, bamboo fibers, corn husk fibers, or mixtures thereof. In one embodiment, the fiber substrate contains pulp fibers.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a cross-sectional view of one embodiment of a multi-layer film that may be made in accordance with the present disclosure;

FIG. 2 is one embodiment of a process that may be used to produce multi-layer films in accordance with the present disclosure;

FIG. 3 is a perspective of one embodiment of a package that may be made in accordance with the present disclosure;

FIG. 4 is a perspective view of another embodiment of a container made in accordance with the present disclosure; and

FIG. 5 is a cross-sectional view of one embodiment of a container made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a multi-layer film having heat seal properties. In accordance with the present disclosure, bio-based polymers and/or sustainable polymers can be combined together to produce a film that is not only biodegradable and/or compostable but is well suited to forming all different types of packaging, including non-rigid packaging. The film of the present disclosure can also be laminated and/or thermoformed to rigid structures for forming various different containers and articles. Not only is the multi-layer film of the present disclosure biodegradable and/or compostable, but the film can also have good transparency properties and/or can have good tear resistance.

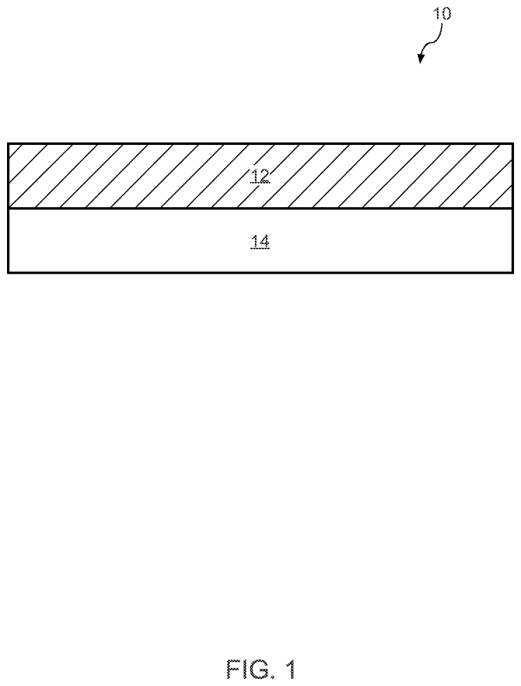

Referring to FIG. 1, one embodiment of a multi-layer film 10 made in accordance with the present disclosure is shown. In the embodiment illustrated, the film 10 includes a first film layer 12 bonded to a second film layer 14. Both film layers 12 and 14 can be made from sustainable materials and can be completely derived from non-fossilized resources. In one aspect, the first film layer 12 contains a cellulose ester polymer that can provide the film with some rigidity while also remaining transparent. The cellulose ester polymer can be combined with a plasticizer in forming the first film layer 12.

The second film layer 14, on the other hand, can comprise a bio-based polyester polymer that has heat seal properties. In one embodiment, for instance, the second film layer 14 can comprise a polybutylene succinate polymer. The second film layer 14, for instance, can contain polybutylene succinate in an amount greater than about 70% by weight, such as in an amount greater than about 80% by weight, such as in an amount greater than about 90% by weight, such as in an amount greater than about 95% by weight. In one particular embodiment, the second film layer 14 can be made entirely (i.e. 100% by weight) from polybutylene succinate.

Although not shown in FIG. 1, the multi-layer film 10 can optionally include a barrier layer positioned between the first film layer 12 and the second film layer 14. The barrier layer can protect the first film layer from moisture and gases and may comprise an aluminum oxide layer.

The multi-layer film 10 as shown in FIG. 1 can have an excellent balance of properties. For example, the multi-layer film can display a heat seal strength when the second film layer is bonded to itself of greater than about 15 N, such as greater than about 18 N, and generally less than about 50 N, when heat sealed at a temperature of 140° C. and at 40 psi for 0.5 seconds. Heat seal strength is determined in accordance with ASTM Test F-2029 (2021).

In addition to excellent heat seal properties, the multi-layer film also has excellent mechanical properties. For example, the multi-layer film can be tear resistant. The multi-layer film, for instance, may display a tear propagation of greater than about 3 N, such as greater than about 3.2 N, such as greater than about 3.4 N, such as greater than about 3.6 N, such as greater than about 3.8 N. The tear propagation is generally less than about 7 N. As used herein, tear propagation is measured according to ASTM Test F-88 (2015).

The multi-layer film of the present disclosure also displays desirable flexibility. For example, cellulose acetate films tend to be relatively stiff while films made from polybutylene succinate have not only low tear resistance but are difficult to handle and manipulate due to its elevated elasticity. Multi-layer films made according to the present disclosure, however, can have a Youngs Modulus of greater than about 500 N/m², such as greater than about 700 N/m², such as greater than about 900 N/m², such as greater than about 1,000 N/m², such as greater than about 1,100 N/m², such as greater than about 1,200 N/m², such as greater than about 1,400 N/m², such as greater than about 1,600 N/m², such as greater than about 1,700 N/m², and less than about 3,000 N/m², such as less than about 2,500 N/m², such as less than about 2,300 N/m², such as less than about 2,000 N/m², such as less than about 1,800 N/m², such as less than about 1,700 N/m². In one aspect, tear propagation and Youngs Modulus can be measured on a 40 micron film. Youngs Modulus can be measured according to ASTM Test D-882.

Multi-layer films made according to the present disclosure can also be highly translucent or transparent if desired. For instance, 40 micron films made in accordance with the present disclosure can display a haze of less than about 20%, such as less than about 18%, such as less than about 16%, such as less than about 14%, such as less than about 13%. The haze is generally greater than about 1%. Haze can be measured according to ASTM Test D1003 (2013). For example, haze can be measured using any acceptable instrument according to the ASTM test including, for instance, a BYK Gardner Haze-Gard 4725 instrument. Haze can be measured on a test film made according to the present disclosure or on a final article.

In addition to the excellent balance of properties as described above, the multi-layer film of the present disclosure can be produced from renewable resources and thus can be completely sustainable. In addition, the multi-layer film is biodegradable and compostable. For example, multi-layer films made according to the present disclosure can pass compostable test EN 13432 after 26 weeks.

Of particular advantage, the multi-layer film 10 as shown in FIG. 1 can be constructed without the use of adhesive tie layers. For instance, the first film layer 12 can be directly bonded to the second film layer 14 without an adhesive layer therebetween. The absence of an adhesive layer, for instance, can improve the biodegradable properties and compostable properties of the film.

The thickness of the multi-layer film can vary widely depending upon the particular application and the desired result. The multi-layer film of the present disclosure, for instance, can be used to produce not only flexible packaging, but can be used in thermoforming applications for producing semi-rigid or rigid products. Thus, film thickness can vary widely.

In one aspect, for instance, the film can have a thickness of from about 10 microns to about 1,000 microns, including all increments of 1 micron therebetween. In one aspect, a thinner film may be desired. For instance, the film can have a thickness of less than about 150 microns, such as less than about 140 microns, such as less than about 130 microns, such as less than about 120 microns, such as less than about 110 microns, such as less than about 100 microns, such as less than about 90 microns, such as less than about 80 microns, such as less than about 70 microns, such as less than about 60 microns, such as less than about 50 microns, such as less than about 40 microns. The thickness of the multi-layer film is generally greater than about 10 microns, such as greater than about 15 microns, such as greater than about 20 microns, such as greater than about 25 microns, such as greater than about 30 microns, such as greater than about 35 microns.

In other embodiments, thicker films may be desired. For instance, the film can have a thickness of greater than about 150 microns, such as greater than about 170 microns, such as greater than about 180 microns, such as greater than about 200 microns, such as greater than about 220 microns, such as greater than about 240 microns, and less than about 500 microns, such as less than about 450 microns, such as less than about 400 microns. In one aspect, the film can have a thickness of from about 200 microns to about 280 microns. In another embodiment, the film can have a thickness of from about 340 microns to about 400 microns.

The relative thickness of the first film layer 12 in relation to the thickness of the second film layer 14 can also vary. In one aspect, for instance, the thickness ratio of the first film layer 12 to the second film layer 14 can be from about 0.5:1 to about 50:1, such as from about 0.9:1 to about 10:1, such as from about 0.9:1 to about 5:1. In one aspect, especially when producing thicker films, the film layer containing the cellulose ester polymer can be thicker than the film layer containing the polybutylene succinate polymer.

The second film layer containing the bio-based polyester polymer, such as polybutylene succinate, can have a thickness of from about 5 microns to about 120 microns, including all increments of 1 micron therebetween. For instance, the second film layer 14 can have a thickness of greater than about 10 microns, such as greater than about 15 microns, such as greater than about 20 microns, such as greater than about 25 microns, such as greater than about 30 microns, and generally less than about 80 microns, such as less than about 70 microns, such as less than about 60 microns, such as less than about 55 microns, such as less than about 50 microns, such as less than about 45 microns, such as less than about 40 microns, such as less than about 35 microns, such as less than about 30 microns, such as less than about 25 microns.

As described above, the first film layer 12 as shown in FIG. 1 can be made from a cellulose ester polymer. Cellulose ester polymers can be not only produced from sustainable resources but are also biodegradable. Cellulose ester polymers, such as cellulose acetate, may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses of the Miscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in producing the film of the present disclosure may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof. Cellulose esters suitable for use in producing the composition of the present disclosure may, in some embodiments, have a molecular weight ranging from a lower limit of about 10,000, 15,000, 25,000, 50,000, or 85,000 to an upper limit of about 125,000, 100,000, or 85,000, and wherein the molecular weight may range from any lower limit to any upper limit and encompass any subset therebetween. In one embodiment, the number average molecular weight of the cellulose acetate may range from 40,000 amu to 100,000 amu, e.g., from 50,000 amu to 80,000 amu.

The cellulose acetate used in the film layer may be cellulose diacetate or cellulose triacetate. In one embodiment, the cellulose acetate comprises primarily cellulose diacetate. In one embodiment, for instance, the cellulose acetate can have a degree of substitution of from about 2.3 to about 2.7, such as from about 2.4 to about 2.5. In one embodiment, the cellulose acetate can have a degree of substitution of about 2.45.

In some embodiments, the cellulose acetate in the composition comprises less than 1 wt. % cellulose triacetate, e.g., less than 0.5 wt. % or less than 0.1 wt. %. In some cases, the cellulose acetate in the composition consists essentially of cellulose diacetate.

In order to form a film, the cellulose acetate in powder or flake form is combined with a solvent and formed into a dope. The dope can then be used in a solvent casting process to form a film. Alternatively, the cellulose acetate can be formulated and injection molded into pellets that may be formed into a film.

When forming a cast film, as described above, the cellulose acetate can be in the form of flakes that are combined with a solvent. The flake form of cellulose acetate may have an average flake size from 5 μm to 10 mm, as determined by sieve analysis. The flake can have low moisture content, optionally comprising less than 6 wt. % water, e.g., less than 5 wt. % water or less than 2.5 wt. % water. In terms of ranges, the flake form may have from 0.01 to 6 wt. % water, e.g., from 0.1 to 2.5 wt. % water or from 0.5 to 2.45 wt. % water.

In forming the solvent cast film, the cellulose acetate may optionally be combined with a film plasticizer. The film plasticizer may vary widely. Suitable film plasticizers may, in some embodiments, include, but are not limited to, triacetin, trimethyl phosphate, triethyl phosphate, tributyl phosphate, triphenyl phosphate, tris(2-chloro-1-methylethyl) phosphate, triethyl citrate, acetyl trimethyl citrate, acetyl triethyl citrate, acetyl tributyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, diethylene glycol, polypropylene glycol, polyglycoldiglycidyl ethers, dimethyl sulfoxide, N-methyl pyrollidinone, propylene carbonate, C1-C20 diacid esters, dimethyl adipate (and other dialkyl esters), resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, aromas (including some described herein, e.g., eugenol, cinnamyl alcohol, camphor, methoxy hydroxy acetophenone (acetovanillone), vanillin, and ethylvanillin), and the like, any derivative thereof, and any combination thereof. In some embodiments, film plasticizers may be food-grade film plasticizers. Examples of food-grade film plasticizers may, in some embodiments, include, but are not limited to, triacetin, trimethyl citrate, triethyl citrate, tributyl citrate, eugenol, cinnamyl alcohol, methoxy hydroxy acetophenone (acetovanillone), vanillin, ethylvanillin, polyethylene glycols, and the like, and any combination thereof.

In one embodiment, the plasticizer is selected from the group consisting of 1,2,3-triacetoxypropane (triacetin), tributyl citrate, diethyl phthalate, triethyl citrate, triphenyl phosphate, tris(clorisopropyl)phosphate, dimethyl phthalate, bornan-2-one, PEG-DGE, PPG-DGE, tributyl phosphate, and combinations thereof. In one aspect, the plasticizer can comprise triacetin, polyethylene glycol, polycaprolactone, or mixtures of two of the above plasticizers or all three of the above plasticizers.

The film layer, in one embodiment, comprises from 55 wt. % to 95 wt. % cellulose acetate, e.g., from 65 wt. % to 90 wt. %, from 70 wt. % to 90 wt. %, or from 75 wt. % to 85 wt. %. In terms of lower limits, the composition may comprise at least 60 wt. % cellulose acetate, e.g., at least 65 wt. %, at least 70 wt. % or at least 75 wt. %. In terms of upper limits, the composition may comprise less than 95 wt. % cellulose acetate, e.g., less than 90 wt. % or less than 85 wt. %.

The film layer, in one embodiment, comprises from 5 wt. % to 45 wt. % plasticizer, e.g., from 5 wt. % to 35 wt. %, from 10 wt. % to 30 wt. %, or from 15 wt. % to 25 wt. %. In terms of lower limits, the composition may comprise at least 5 wt. % plasticizer, e.g., at least 10 wt. %, at least 15 wt. % or at least 18 wt. %. In terms of upper limits, the composition may comprise less than 95 wt. % plasticizer, e.g., less than 40 wt. %, less than 35 wt. %, less than 30 wt. %, or less than 25 wt. %.

The second film layer 14, on the other hand, is made from a biodegradable polyester polymer. Any suitable biodegradable polyester polymer may be used as long as the polymer has desired or sufficient heat seal properties. The second film layer, for instance, provides the multi-layer film with heat seal properties while the first film layer containing the cellulose ester polymer provides good tear resistance and improved modulus properties. In one aspect, the biodegradable polyester polymer comprises polybutylene succinate.

Optionally, the multi-layer film can include a barrier layer positioned between the first film layer and the second film layer. The barrier layer can be made from aluminum oxide or from cellulose particles or other barrier materials. The barrier layer can increase the barrier properties of the multi-layer film against moisture and gases.

Each film layer contained in the multi-layer film 10 as shown in FIG. 1 can also contain various other additional and optional components and additives, e.g., tackifiers, flame retardants, antioxidants, antibacterial agents, antifungal agents, colorants, pigments, dyes, UV-stabilizers, viscosity modifiers, processing additives, aromas, and the like, and any combination thereof. The amount of the additives may vary widely. Generally speaking, the one or more additives may be present in an amount ranging from 0.01 to 10 wt. %, based on the total weight of the film layer, e.g., from 0.03 to 2 wt. %, or from 0.1 to 1 wt. %.

Tackifiers may, in some embodiments, increase the adhesive properties of a film layer described herein. Tackifiers, however, are entirely optional and may be excluded from the multi-layer film. Tackifiers suitable for use in conjunction with each film layer described herein may, in some embodiments, include, but are not limited to, methylcellulose, ethylcellulose, hydroxyethylcellulose, carboxy methylcellulose, carboxy ethylcellulose, amides, diamines, polyesters, polycarbonates, silyl-modified polyamide compounds, polycarbamates, urethanes, natural resins, natural rosins, shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl) quaternary amines, p-T-amyl-phenols condensed with formaldehyde, dialkyl amino alkyl (meth)acrylates, acrylamides, N-(dialkyl amino alkyl) acrylamide, methacrylamides, hydroxy alkyl (meth)acrylates, methacrylic acids, acrylic acids, hydroxyethyl acrylates, and the like, any derivative thereof, and any combination thereof. In some embodiments, tackifiers suitable for use in conjunction with the film layer described herein may be food-grade tackifiers. Examples of food-grade tackifiers may, in some embodiments, include, but are not limited to, methylcellulose, ethylcellulose, hydroxyethylcellulose, carboxy methylcellulose, carboxy ethylcellulose, natural resins, natural rosins, and the like, and any combination thereof.

Flame retardants suitable for use in conjunction with the film layer described herein may, in some embodiments, include, but are not limited to, phosphates, catechol phosphates, resorcinol phosphates, aromatic polyhalides, and the like, and any combination thereof.

Antifungal agents suitable for use in conjunction with the film layer described herein may, in some embodiments, include, but are not limited to, polyene antifungals, e.g., natamycin, rimocidin, filipin, nystatin, amphotericin B, candicin, and hamycin, imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, and any combination thereof.

Colorants, pigments, and dyes suitable for use in conjunction with the film layers described herein may, in some embodiments, include, but are not limited to, plant dyes, vegetable dyes, titanium dioxide, silicon dioxide, tartrazine, EI 02, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, nickel titanate, benzimidazolone orange gl, solvent orange 60, orange dyes, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL Brilliant Yellow K-6G liquid, CARTASOL Yellow K-4GL liquid, CARTASOL Yellow K-GL liquid, CARTASOL Orange K-3GL liquid, CARTASOL Scarlet K-2GL liquid, CARTASOL Red K-3BN liquid, CARTASOL Blue K-5R liquid, CARTASOL Blue K-RL liquid, CARTASOL Turquoise K-RL liquid/granules, CARTASOL Brown K-BL liquid), FASTUSOL® dyes (an auxochrome, available from BASF) (e.g., Yellow 3GL, Fastusol C Blue 74L), and the like, any derivative thereof, and any combination thereof. In some embodiments, when the colorant is titanium dioxide is utilized as the colorant, the titanium dioxide may also function to increase the stiffness of the film. In one embodiment, solvent dyes may be employed.

In one embodiment, the composition used to form a film layer is free of any conventional anti-blocking agents, such as various particles including oxides, carbonates, talc, and the like.

In some embodiments, each film layer further comprises a releasing agent, which allows the resulting film to release from various components during or after the production process, e.g., releasing from a casting band. In one embodiment, the film layer comprises from 0.01 wt. % to 10 wt. % releasing agent, e.g., from 0.05 wt. % to 5 wt. %, from 0.05 wt. % to 1 wt. %, or from 0.05 wt. % to 0.5 wt. %. In one embodiment, the releasing agent comprises stearic acid or sorbitan monostearate. The releasing agent is preferably added to, e.g., mixed into, the dope. In such cases, the release agent preferably is dissolved into the dope. In one embodiment, the releasing agent is deposited or injected onto the casting band upon which the film layer is cast. As the film layer is released from the casting band, some of the releasing agent may remain with the film layer and/or some of the release agent may remain with the casting band (based on the attraction of the release agent to the metal).

The multi-layer film 10 as shown in FIG. 1 can be made in various different ways. In one aspect, for instance, the first film layer 12 and the second film layer 14 can be made separately and brought together to form the film 10. Alternatively, one of the film layers can first be formed and the other film layer can be extruded onto the formed film layer. In still another embodiment, the multi-layer film can be made from co-extruded layers.

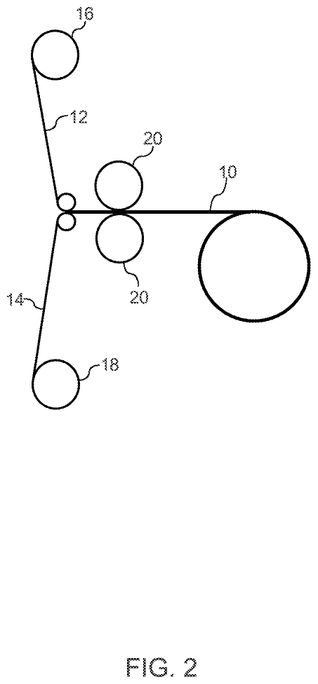

In one particular embodiment, however, the first film layer 12 containing the cellulose ester polymer comprises a cast film that is formed and then combined with the second film layer 14. For example, referring to FIG. 2, one embodiment of a process for forming the multi-layer film 10 is shown. As illustrated, the first film layer 12 is unwound from a supply roll 16 while the second film layer 14 is unwound from a supply roll 18. The first film layer 12 and the second film layer 14 can then be guided between a pair of calender rolls 20 that are used to form the multi-layer film 10. The formed multi-layer film 10 can be wound into a roll 22.

The first film layer 12 can be bonded to the second film layer 14 using various different techniques and processes. In one application, for instance, the calender rolls 20 can be heated for thermally bonding the two film layers together.

In an alternative embodiment, a solvent can be applied in between the two film layers 12 and 14 for causing the two film layers to bond together without the use of an adhesive layer. The solvent, for instance, can be a solvent that causes the surface of at least one of the film layers to dissolve and bond to the adjacent film layer. In one embodiment, a solvent is selected that causes both film layers to dissolve and combine together for forming a strong bond. In one embodiment, for instance, the solvent applied between the two film layers 12 and 14 can comprise acetone alone or in combination with a plasticizer. For instance, in one aspect, the solvent comprises acetone combined with triacetin.

The solvent can be applied to both or one of the film layers using any suitable method. In one embodiment, for instance, the solvent can be sprayed onto one or both film surfaces. Alternatively, the solvent can be drip fed between the nip formed by the calender rolls 20.

The multi-layer film 10 made in accordance with the present disclosure can be used in numerous and diverse applications. In one aspect, for instance, the multi-layer film may be used as a packaging material to form packages alone or in combination with other materials. For instance, due to the heat seal properties of the second film layer 14, the multi-layer film 10 can be adhered together to form a flexible package that can be translucent or transparent. The multi-layer film 10 can be used to produce all different types of packages. The packages can be flexible or can be semi-rigid. The packages can be used to hold and store a limitless variety of items including, for instance, snack foods, candy, hardware, all other types of food stuffs, consumer products, and the like. The second film layer 14 is used to seal the two opposing film layers together using heat and pressure, ultrasonic bonding, or any other suitable method after the package has been filled with its contents.

The second film layer, for instance, can have heat seal properties such that the temperature needed to initiate sealing of the package is lower than the softening point of the first film layer 12 so that the package does not degrade, wrinkle, or pucker during the sealing process.

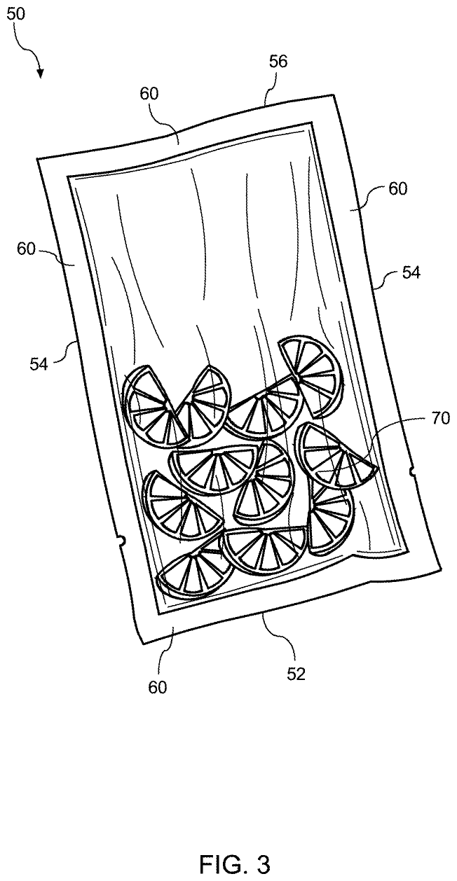

For exemplary purposes, referring to FIG. 3, a package 50 that may be formed in accordance with the present disclosure is shown. The package 50 can be made from the multi-layer film 10 as illustrated in FIG. 1. The package 50 includes a bottom 52, sides 54, and a top 56. The package 50, in this embodiment, is formed from two opposing flexible films. Each side of the package can be made from an individual piece of film or can be formed by folding a film in an overlapping relationship. The second film layer of the present disclosure can be used to seal the margins of the package. For instance, as shown in FIG. 3, the package includes sealed margins 60 formed by applying heat and pressure to the heat seal layers.

As shown, the package 50 contains an item 70, such as a food product. Packages made according to the present disclosure can be used to contain and seal various different products, such as snack foods, hardware, consumer products, or the like. In addition, the package 50 can be used to contain flowable materials, such as liquids, including water, fruit juice, and the like. The package 50 can also be used to contain flowable gels, such as shampoos, conditioners, other hair products, toothpaste, and the like.

When filling packages as shown in FIG. 3, typically two layers of film are brought together and sealed at the margins to produce a hollow interior with a volume. A product or products are then loaded into the hollow interior and the remaining side of the package is heat sealed. In order to heat seal the package, the open end of the package is typically engaged with a sealing device that applies heat and pressure in an amount sufficient for the heat seal layers to activate and form thermal bonds.

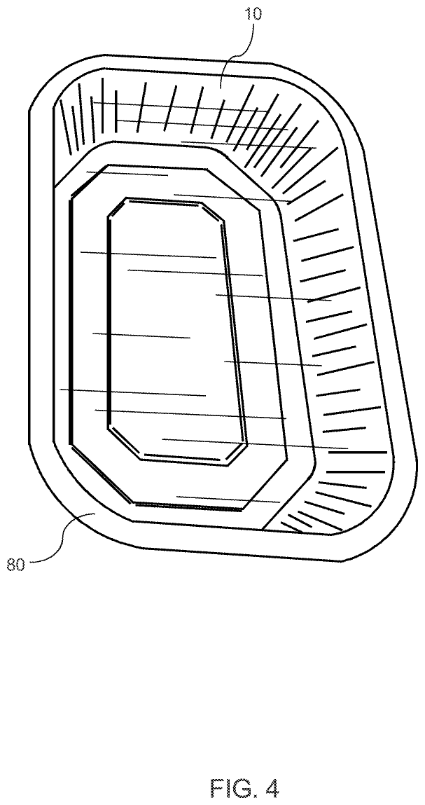

In addition to forming entire packages, the multi-layer film of the present disclosure can also be used as a lid or sealing film on a package. For instance, referring to FIG. 4, a rigid container 80 is shown. The top of the container 80 is sealed by the multi-layer film 10 of the present disclosure.

The multi-layer film of the present disclosure can also be used in thermoforming applications to form thermoformed products. The thermoformed product can be made from the film itself in order to produce a rigid or semi-rigid package. In addition, the multi-layer film can be laminated to a substrate for forming a package or container. In one aspect, the substrate can be formed from natural fibrous materials in order to produce a container that is biodegradable and compostable.

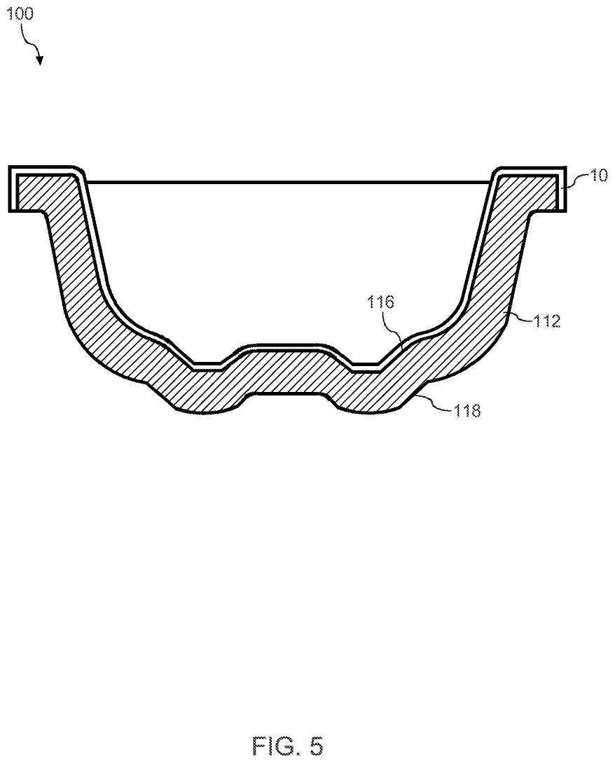

Referring to FIG. 5, for instance, one embodiment of a container 100 made in accordance with the present disclosure is shown. The container 100 includes a fibrous substrate 112 that has been laminated to a multi-layer film 10 made in accordance with the present disclosure. In the embodiment illustrated in FIG. 5, the multi-layer film 10 has been laminated to the interior surface 116 of the fibrous substrate 112. Consequently, the fibrous substrate 112 forms the exterior surface 118 of the container 100. In other embodiments, however, the fibrous substrate 112 can be completely enclosed within the multi-layer film 10. For instance, the multi-layer film 10 can extend over the interior surface 116 and over the exterior surface 118. The multi-layer film 10 made in accordance with the present disclosure forms a liquid impermeable surface of the container 100. In addition, the container 100 can be filled with a food product and frozen, cooled, and/or heated without the multi-layer film 10 delaminating from the fibrous substrate 112.

The fibrous substrate 112 can be made from any suitable fibrous material, particularly organic fibers such as plant fibers. In one embodiment, the fibrous substrate 112 is formed from pulp fibers. Pulp fibers refer to delignified fibers that have undergone a pulping process, such as in a digester. The pulp fibers, for instance, can comprise wood pulp fibers. Wood pulp fibers include softwood fibers, hardwood fibers, or combinations thereof.

Other fibers that may be present within the fibrous substrate 112 include cotton fibers, linen fibers, regenerated cellulose fibers, such as rayon fibers or viscose fibers, recycled textile fibers, and the like. In one embodiment, the fibrous substrate 112 can contain bast fibers either alone or in combination with wood pulp fibers. Bast fibers that can be present in the fibrous substrate 112 include flax fibers, sugarcane fibers, bamboo fibers, hemp fibers, abaca fibers, kozo fibers, fibers from ground nutshells, mixtures thereof, and the like. In still another aspect, the fibrous substrate 112 can contain corn husk fibers.

When formed partially or exclusively from pulp fibers, particularly wood pulp fibers, the fibrous substrate 112 can have integrity through hydrogen bonding. In one aspect, a binder can be added during formation of the fibrous substrate in order to increase integrity. Binders that can be incorporated into the fibrous substrate 112 include all different types of natural gums. Natural gums that can be used include guar gums, gum arabic, alginate gums, and the like. Other binders that can be used include starch, polyvinyl alcohol, polyglycolic acid, and mixtures thereof.

In one aspect, the binder can be a biodegradable polymer, such as a biodegradable aliphatic polyester. Biodegradable polyesters include, for instance, polylactic acid, poly-E-caprolactone, polyhydroxybutyrate, poly(3-hydroxyvalerate), polybutylene adipate succinate, and mixtures thereof.

When present, one or more binders can be contained in the fibrous substrate 112 in an amount less than about 5% by weight, such as in an amount less than about 3.5% by weight, such as in an amount less than about 3% by weight, such as in an amount less than about 2.5% by weight, and generally in an amount greater than about 0.1% by weight, such as in an amount greater than about 0.5% by weight, such as in an amount greater than about 1% by weight.

The fibrous substrate 112 can be made using various different processes. In one aspect, the fibrous substrate 112 can be compression molded. The fibrous substrate 112, for instance, can be compression molded using a wet or aqueous slurry of the fibrous materials or can be formed in an airlaid process. When formed in an airlaid process, a fluff pulp material can be placed in a mold and compacted.

The fibrous substrate 112 can have a thickness and a basis weight that can vary depending upon the particular application and the desired result. For example, the fibrous substrate 112 can be relatively compact in one embodiment or can comprise a higher bulk material in an alternative embodiment. As will be described in greater detail below, the fibrous substrate 112 can have any suitable thickness or basis weight as long as the fibrous substrate 112 maintains a level of air permeability that permits lamination to the multi-layer film 10. In one aspect, the fibrous substrate has a basis weight of from about 12 gsm to about 80 gsm, such as from about 14 gsm to about 25 gsm. The thickness of the fibrous substrate can be greater than about 0.3 mm, such as greater than about 0.5 mm and less than about 10 mm, such as less than about 5 mm, such as less than about 1 mm, such as less than about 0.7 mm.

The fibrous substrate 112 can be formed in a manner such that the substrate is air permeable and porous. In one aspect, the porous nature of the fibrous substrate 112 can be used to assist in laminating the multi-layer film 10 to a surface of the fibrous substrate 112. For instance, pressure can be applied to the multi-layer film 10 and/or a suction force or vacuum can be applied to the opposite side of the fibrous substrate 112 during the lamination process. In this manner, airflow through the porous substrate 112 maintains pressure between the multi-layer film 10 and a surface of the fibrous substrate 112 for ensuring that an adequate bond is produced between the two layers. Various different laminating processes can be used to produce the container 100. For instance, the container 100 can be produced through vacuum thermoforming, drape forming, high pressure forming, plug assist forming, hydroforming, or match die forming. In general, the multi-layer film 10 is heated and pressure is applied between the fibrous substrate 112 and the film layer 114 for a time of from about 1 to about 60 seconds for forming a bond between the two layers. During the process, the fibrous substrate 112 can be placed inside a cavity of a mold of similar geometry in order to provide support to the fibrous substrate walls during forming the product. When producing the container 100, the second film layer 114 made from the bio-based polyester polymer, such as polybutylene succinate, is placed in contact with the interior surface 116 of the fibrous substrate 112.

One further advantage to using the multi-layer film of the present disclosure is that the film is capable of receiving printed matter. Thus, printed matter, logos, trademarks, company names, and designs can be applied to the first film layer when producing various articles. The film layer, for instance, can be subjected to screen printing, laser marking, pad printing, digital printing, dye sublimation, transfer printing, offset printing, digital offset printing, or gravure printing. In one aspect, laser marking is used instead of printing.

The present disclosure may be better understood with reference to the following example.

### Example

A cellulose ester polymer film and a polybutylene succinate film were produced. The films were combined to form a multi-layer film in accordance with the present disclosure. Each of the film layers were tested for various properties and compared with the properties of the multi-layer film.

The cellulose ester polymer film layer contained primarily cellulose diacetate combined with 17% by weight plasticizer, namely triacetin. The cellulose ester polymer layer was a cast film having a thickness of 20 microns. The polybutylene succinate film layer was made entirely from polybutylene succinate and also had a thickness of 20 microns.

The multi-layer film of the present disclosure was produced by applying acetone between the two film layers. The following results were obtained:

| | Cellulose | Polybutylene | 40 micron |
|---|---|---|---|
| | ester | succinate | multi- |
| | polymer | film | layer |
| Property Tested | film layer | layer | film |
| Thickness (microns) | 20 | 20 | 40 |
| Haze (ASTM D1003) (%) | 0.8 | 26.8 | 12.5 |
| Heat Seal Strength @ 140° C., 40 | N/A | 20 | 20 |
| psi for 0.5 seconds - polybutylene | | | |
| succinate film layer bonded to | | | |
| polybutylene succinate film layer | | | |
| (N) | | | |
| Heat Seal Strength @ 140° C., 40 | 0.01 | 3.2 | 2.86 |
| psi for 0.5 seconds - polybutylene | | | |
| succinate film layer bonded to | | | |
| cellulose ester polymer film layer | | | |
| (N) | | | |
| Tear propagation (N) | 0.014 | 4.31 | 3.84 |
| Youngs Modulus (ISO Test 527-1) | 2500 | 269 | 1700 |
| (MPa) | | | |
| Thermal lamination to plain board | No bond | 1.39 | 1.23 |

As shown above, the multi-layer film made according to the present disclosure had an excellent balance of properties.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A multi-layer film comprising:
a first film layer comprising a cellulose ester polymer combined with a plasticizer, the first film layer having a first surface and a second and opposite surface; and
a second film layer bonded adjacent to the first surface of the first film layer, the second film layer comprising a heat sealable bio-based polyester polymer, the biobased polyester polymer comprising a polybutylene succinate polymer.

2. A multi-layer film as defined in claim 1, wherein the second film layer is directly bonded to the first surface of the first film layer.

3. A multi-layer film as defined in claim 1, wherein the multi-layer film does not include an adhesive layer positioned between the first film layer and the second film layer.

4. A multi-layer film as defined in claim 1, wherein the multi-layer film further comprises a barrier layer positioned between the first film layer and the second film layer.

5. A multi-layer film as defined in claim 1, wherein the cellulose ester polymer consists essentially of cellulose diacetate.

6. A multi-layer film as defined in claim 1, wherein the first film layer contains the cellulose ester polymer in an amount from about 55% by weight to about 95% by weight and contains the plasticizer in an amount from about 5% by weight to about 45% by weight.

7. A multi-layer film as defined in claim 1, wherein the plasticizer contained in the first film layer comprises triacetin, polyethylene glycol, a polycaprolactone, or mixtures thereof.

8. A multi-layer film as defined in claim 1, wherein the first film layer is a cast film.

9. A multi-layer film as defined in claim 1, wherein the multi-layer film has a thickness of from about 10 microns to about 1,000 microns.

10. A multi-layer film as defined in claim 1, wherein the film has a thickness of from about 150 microns to about 400 microns.

11. A multi-layer film as defined in claim 1, wherein the film has a thickness of from about 10 microns to about 150 microns.

12. A multi-layer film as defined in claim 1, wherein the second film layer has a thickness of from about 10 microns to about 40 microns.

13. A multi-layer film as defined in claim 1, wherein the film displays a haze of less than 20% when tested according to ASTM Test D1003.

14. A multi-layer film as defined in claim 1, wherein, when the second film layer is bonded to itself, the multi-layer film displays a heat seal strength of greater than about 15 N when heat sealed at a temperature of 140° C. and at a pressure of 40 psi for 0.5 seconds.

15. A multi-layer film as defined in claim 1, wherein the film displays a tear propagation of greater than about 3 N.

16. A multi-layer film as defined in claim 1, wherein the multi-layer film displays a Young Modulus of greater than about 700 N/m² when tested according to ASTM Test D-882.

17. A multi-layer film as defined in claim 1, wherein the multi-layer film passes a compostable test EN 13432.

18. A multi-layer film as defined in claim 1, wherein the second film layer comprises polybutylene succinate in an amount greater than about 70% by weight.

19. A package made from the multi-layer film as defined in claim 1, wherein the package includes an interior enclosure having an interior surface and wherein the interior surface comprises the second film layer of the multi-layer film.

20. A composite article comprising a fiber substrate, the fiber substrate comprising a network of biodegradable and/or paper recyclable fibers, the fiber substrate defining a surface, and wherein the multi-layer film as defined in claim 1 is laminated to the surface of the fiber substrate and wherein the fiber substrate has a three-dimensional shape and wherein the multi-layer film has been subjected to sufficient heat and pressure in order to assume the shape of the fiber substrate.
